(19) United States
(12) Patent Application Publication
(10) Pub. No.: US 2003/0001117 A1
(43) Pub. Date: Jan. 2, 2003

(54) Dimensional measurement apparatus for object features

(76) Inventor: Kwangik Hyun, Gilroy, CA (US)

Correspondence Address: Kwangik Hyun, 1431 Briarberry Lane, Gilroy, CA, 95020, US

(21) Appl. No.: 10/144,057

(22) Filed: May 10, 2002

Related U.S. Application Data
(60) Provisional application No. 60/291,070, filed on May 15, 2001.

(51) Int. Cl. G01N 21/86; G01V 8/00

(52) U.S. Cl. 250/559.19

(57) ABSTRACT

A dimensional measurement apparatus comprises one photographic device with plural lighting devices. Properly disposed devices enable dimensional measurements of object features in two- and three-dimensional spaces. To achieve the measurements, proper device calibrations are required. After defining the disposition of device setups and their calibrations, the devices can be integrated with additional electronic hardware to obtain object feature data from the integrated devices. The obtained object feature information will be processed into three-dimensional world coordinates by utilizing the devices calibration data. Using the resultant data after processing, object feature inspections and volumetric representations could be realized. The apparatus provides dual line-scanning capability with opposite directional incident angle projections for the illuminations. The dual line-scanning method provides advantages that it reduces data gathering time compare to a single scanning method in a fixed resolution, and it also enhances measurement accuracies since the dual line-scanning method reduces object occlusion problem and errors from the width of the illuminator especially for the curved shaped object.

### CROSS-REFERENCE TO RELATED APPLICATION

This application claims the benefit of Provisional Patent Application Ser. No. 60/291,070 filed May 15, 2001.

### FEDERALLY SPONSERED RESEARCH

Not Applicable

SEQUENCE LISTING OR PROGRAM

Not Applicable

### FIELD OF INVENTION

This invention relates to a dimensional measurement apparatus of two- and three-dimensional object features. In particular, the present invention relates to object feature representation apparatus as well as inspection apparatus utilizing the measured two- and three-dimensional object feature information.

### BACKGROUND OF THE INVENTION

PCB manufacturing industry faces to an innovation of technology trends that electronic devices are getting smaller and more complicate than previous industry trend when information technology is growing with hardware such as Personal Digital Assistances (PDAs), palm top computer as well as several Personal Communication Systems (PCS) (i.e., cell phone). By emerging these small-size devices, Print Circuit Board (PCB) manufacturing industry needs to provide such a small-size compact electronic devices that are composed of many small electronic parts mounted. To produce such devices, manufacturing processes needs high precision technologies as well as high precision tools for inspection. One of bottlenecks for the manufacturing process is a requirement of three-dimensional inspection. Since increase of product yield is one of the important issues for PCB manufacturing industry, proper equipments are required to minimize defective products at the end of the manufacturing process. However, several types of inspections for intermediate processes are required before completing manufacturing processes to reduce defective product scraps at the final manufacturing process.

The followings are brief intermediate inspection processes for the PCB manufacturing processes. Bare PCB itself needs to be inspected whether there are no defects by checking its flatness, hole size, hole location and hole existence for preparation of actual electronic parts assembly. Also, etching lines need to be inspected whether there are any undesired shorts or opens in the circuit using Automatic Optical Inspection (AOI) equipment as an example. After these inspections are carried out, solder pastes are applied to pads for electronic parts mounting and interconnection of the circuits. Before mounting the parts, solder paste inspection is carried out to make sure that proper solder pastes have desired amount of pastes as well as if the pastes are applied at the correct position of the pads. After mounting the parts on the pads, also, existence of the parts as well as parts mounting status in position-wise needs to be checked. X-ray inspection could be used to take a picture of internal thru-hole soldering status between layers. These serial inspections mostly need specially designed equipments to carry out inspections of the specific defect types.

Some of the most complicate and accuracy-requiring inspections are solder pastes as well as chip carriers (such as Ball Grid Arrays (BGAs)) inspections.

Due to the technology trend of electronic devices such as PDA, portable computer and small-size personal communication devices such as PCS, manufacturing processes require high precision manufacturing technologies to deal with compact size, densely populated print circuit boards. To facilitate the size constraint, there are several types of chip carriers of semiconductor packages such as PGA (Pin Grid Array), QFP (Quad Flat Package), BGA (Ball Grid Array) etc. These semiconductor packages are to be mounted on the PCB that has solder pastes deposited on the pads. However, once the packages are loaded on the PCB, the PCB will carry out the reflow process. During reflow process with high temperature application to the PCB, the amount of solder paste deposition will affect to the product and may cause short or open defects as well. Additionally, BGA has its own solder balls on the package so that they will be molten to be interconnected to the PCB conductive pads mechanically and electrically. If the solder balls on the package are too small, too much or missing, these defective packages cause mal-interconnections as well as misplacements of the package on the PCB, which finally cause electronic functional defect mal-interconnections. as well as misplacements of the package on the PCB, which finally cause electronic functional defect.

To reduce the product defects, some of the defects are required electrical tests for the inspection; others need optical inspection such as cosmetic defects (i.e., pattern missing, foreign materials, character or mark imprint missing or distortions as well). However, current technology could mostly cover these cosmetic defects. Moreover, these defects were existed in the previous time so that the required technologies already provide solutions to resolve them. Since the electronic parts are getting smaller and the PCB size is getting smaller and compact, inspection metrologies are changed toward complicate and precise with shorter throughput. Especially, to accommodate the smaller and high functional electronic parts, manufacturing processes need to be changed to provide solutions for the changing trends. Some of the defect types require a volumetric inspection for accurate and efficient defect analyses. To carry out inspections for these defect types, three-dimensional measurement apparatus can be utilized.

Additionally, three-dimensional inspection can be utilized for a solder paste inspection. The inspection controls solder paste volume applied to conductive pads on the PCB as well as accurate paste application positions. After deposition of the solder paste, Surface Mount Device (SMD) will put all the electronic parts. The solder paste will hold the parts until the electronic parts mountings are done. The following manufacturing process is reflow process that a certain temperature will be applied so that solders are supposed to be molten. This reflow process actually accomplishes electrical and mechanical interconnection between electronic part pads and the conductive pads on the surface of the PCB. However, if the solder paste deposition is too small, it may cause a circuit open with unstable electrical as well as mechanical interconnections during the reflow process. If the solder paste deposition is too much, the circuit may be short to the adjacent conductive pads.

As described above on the needs of complicate and accuracy-requiring inspections for the solder pastes as well as chip carriers (such as Ball Grid Arrays (BGAs)) in the PCB manufacturing industry, dimensional measurement methodologies and equipments are required to increase a production yield and for a better product quality.

U.S. Pat. No. 4,733,969 issued to Steven K. Case et. al. discloses a sensor system including a camera and an illuminator disposed properly to measure a three-dimensional object. The illuminator is located vertically to a measurement surface with a photo detector disposed at an angle. Generally three-dimensional measurement system with a use of illuminator as a light source has a shadow effect due to an object height that blocks the illuminator. Also if an illuminator is projected to an object vertically, a reflected light from the object may show reflections from an object as well as from a lower surface.

U.S. Pat. No. 5,859,924 issued to Kuo-Ching Liu et. al. described three-dimensional vision system with two position sensing detectors. To minimize a shadow effect, two photo diode arrays were employed. Additionally, another photo diode array is attached so as to get a two dimensional image data. The system can obtain 3D information using simple optical triangulation method. However, since the illuminator is projected from the top and the system measures reflected image from an object, it's difficult for the system to measure edge portions of a steeped curved shape such as ball shape. Also the measuring points have a two dimensionally projected points distribution, in other word, a uniformly distributed points which is not proper to describe a three dimensional object.

U.S. Pat. No. 6,072,898 issued to Elwin M. Beaty et. al. described a system to measure three-dimensional data by utilizing shadows of illuminations. By measuring the shadow size of an object, three-dimensional data is calculated. This method is good for pass-fail inspection since the method simply provides a maximum height of the object. However, it has difficulties to measure dimensional properties such as volume as well as height of fine curved-surfaces such as solder paste as well as file BGA balls.

Objects and Advantages

Comparing to the previous arts, the presented invention advantages are:

(a) to provide an apparatus to measure three-dimensional object by utilizing plural illuminators for faster measurement simultaneously;

(b) to provide an apparatus for precise and accurate measurement of a curved shape;

(c) to provide an apparatus for occlusion-minimized measurement;

(d) to provide an apparatus for two and three-dimensional measurement simultaneously.

### SUMMARY OF THE INVENTION

In the present invention, a dimensional measurement method provides a way of measuring two- and three-dimensional object features within photographic device field of view with two properly disposed lighting devices (i.e., lasers). Utilizing this method, three-dimensional object feature representation and inspection can be carried out by the presented dimensional measurement apparatus.

The dimensional measurement apparatus comprises one photographic device with plural lighting devices. Properly disposed devices enable dimensional measurements of object features in two- and three-dimensional spaces. To achieve the measurements, proper device calibrations are required. After defining the disposition of device setups and their calibrations, the devices can be integrated with additional electronic hardware to obtain object feature data from the integrated devices. The obtained measured object feature information will be processed into three-dimensional world coordinates by utilizing the devices calibration data. Using the resultant data, object feature inspections and volumetric representations could be realized. The apparatus provides dual line-scanning capability with opposite directional incident angle projections for the illuminations. The dual line-scanning method provides advantages that it reduces data gathering time compare to a single scanning method in a fixed resolution, and it also enhances measurement accuracies since the dual line-scanning method reduces object occlusion problem and errors from the width of the illuminator especially for the curved shaped object.

The measurement hardware is consisted of two lighting devices that generate lines of light disposed opposite directions each other, and the photographic device is located so as to view the reflections of the two lightings from the defined object feature surface, that are interfaced with a processor. To do interface of the devices for measurement, the photographic device needs frame grabber to grab the photographic device image. Input/output controller in conjunction with the processor controls the lighting devices (i.e., lasers and illuminator). To view a real object features and to define the inspection area for the features, an illuminator is attached under the photographic device. The lens system attached to the photographic device provides capabilities to view the lines of light reflected from the surface of the object features as well as the image reflected from the surface of the PCB by illumination.

The photographic device (i.e., CCD (charge coupled device) and CMOS (complementary metal oxide semiconductor) cameras) is to be selected to image a certain wavelength (i.e., 670 nm wavelength) of the lighting sources. By adjusting the light sources with opposite incident angles toward an object feature and the selected photographic device position, the photographic device grabs the two reflected line images at the same time. To convert the reflected line images into two- and three-dimensional world coordinates, optical calibrations need to be performed in advance. The optical calibrations include two-dimensional photographic device calibration and three-dimensional optical geometric calibration using standard optical triangulation principals. The grabbed images will be processed and machined using image processing algorithms such as model-based image filtering, feature segmentation and feature extraction algorithms to extract useful object feature height information in the image space. Using the optical calibration results, all the obtained object feature information can be interpreted and represented into two- and three-dimensional world coordinate space. Based on the inspection or the representation algorithms, the extracted image space information of the object features will be visualized and stored in respectively desired formats.

To perform the dimensional measurement for a desired inspection area, additional traversing mechanism needs to be integrated. The measurement apparatus that measures a predefined area consists of the optical dispositions (such as a photographic device, lighting devices and illuminator) and X-Y-Z axis traversing mechanism integrated with control hardware and software algorithms. The apparatus also has input/output devices such as monitor and keyboard, and hardware such as frame grabber for interface between the processor and optical arrangements.

### BRIEF DESCRIPTION OF THE DRAWINGS

The present invention will be readily apparent from the following more detailed description of exemplary embodiments and accompanying drawings wherein:

FIG. 1 is a block diagram of measurement head of a first exemplary representative embodiment of the present invention;

FIG. 2(a) and FIG. 2(b) are detailed schematic diagrams for dimensional measurement method (for left-half image analysis) according to the present invention;

FIG. 3(a) and FIG. 3(b) are detailed schematic diagrams for dimensional measurement method (for right-half image analysis) according to the present invention;

FIG. 4(a), FIG. 4(b), FIG. 4(c) and FIG. 4(d) are illustrations of photographic image samples corresponding to the various object features;

FIG. 5(a), FIG. 5(b) and FIG. 5(c) illustrate dual-scanning method in the content of measuring points;

FIG. 6(a) and FIG. 6(b) are calibration target samples that can be used for optical calibration according to the present invention;

FIG. 7 is a flowchart of the dimensional measurement procedure;

FIG. 8 is a flowchart of the photographic device calibration procedure for the measurement according to the present invention;

FIG. 9 is a dimensional measurement apparatus block diagram of a second exemplary representative embodiment of the present invention;

FIG. 10 is coordinate systems to obtain the three-dimensional information using dimensional measurement apparatus using X-Y-Z traversing mechanism.

Reference Numerals In Drawings

| | | | |
|---|---|---|---|
| 101 | measurement head | 102 | laser |
| 103 | laser | 104 | photographic device |
| 105 | lens system | 106 | optical lens system |
| 107 | illuminator | 108 | line of light |
| 109 | mirror | 111 | mirror |
| 112 | object feature | 113 | frame grabber |
| 114 | Laser/illuminator controller | 115 | display device |
| 116 | processor | 117 | memory |
| 118 | line of light | 119 | mirror |
| 120 | reflected lines of light | 121 | reflected lines |
| 201 | image | 202 | image centerline |
| 203 | line of light | 204 | photographic device |
| 205 | viewing angle | 206 | laser |
| 207 | line of light | 208 | laser project angle |
| 209 | object | 210 | reflected line |
| 211 | photographic device image | 212 | left half size |
| 213 | calibration plane | 301 | image |
| 303 | reflected line of light | 306 | laser |
| 307 | line of light | 308 | laser project angle |
| 309 | object | 310 | reflected line |
| 312 | right half size | 402 | line |
| 403 | line | 404 | surface |
| 405 | projected lines of light | 406 | object feature |
| 407 | distorted line | 408 | distorted line |
| 412 | object feature | 410 | projected line |
| 411 | projected line of light | | |
| 412 | previous measured point | | |
| 503 | previous measured point | | |
| 504 | subsequent measurement point | | |
| 505 | subsequent measurement point | 506 | measurement point |
| 507 | measurement point | | |
| 508 | subsequent measurement point | | |
| 509 | subsequent measurement point | 510 | measurement points |
| 511 | line | | |
| 512 | subsequent measurement point | | |
| 513 | subsequent measurement point | 514 | point |
| 601 | calibration target | | |
| 602 | calibration target with dots | | |
| 603 | small dots with the same pitch | | |
| 605 | calibration target | 606 | intersection point |
| 607 | pitch | 608 | pitch |
| 701 | image | 701 | image |
| 703 | defined area | 704 | coordinate space |
| 705 | traversing mechanism | 801 | frame grabber |
| 803 | calibration target | 805 | apparatus design |
| 901 | memory | 902 | input device |
| 903 | X-Y-Z traversing mechanism | 904 | I/O controller |
| 905 | image data processor | 909 | measurement head |
| 906 | fixed frame | | |
| 907 | X-Y-Z traversing mechanism | | |
| 908 | object feature | 909 | measurement head |

### DESCRIPTION OF THE PREFERRED EMBODIMENTS

The embodiments of the present invention will be described with reference to the attached drawings.

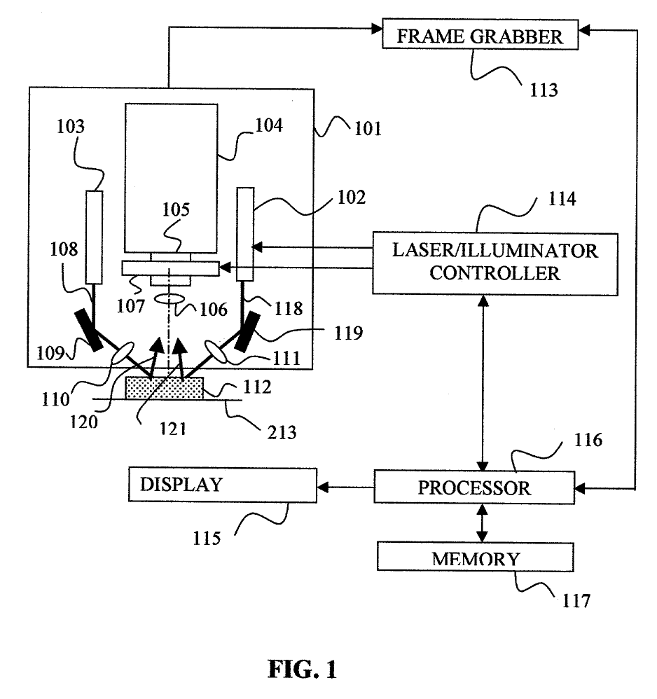

FIG. 1 is a block diagram of measurement head of a first exemplary representative embodiment of the present invention. This block diagram illustrates a dimensional measurement apparatus with a present invention of measurement head 101. The measurement head 101 consists of photographic device 104, lens system 105, illuminator 107, two mirrors 109, 119 and two lasers 102, 103 with optical lens systems 106, 109, 111. The photographic device 104 needs to be set up to focus a measuring object feature 112 for a good focused image gathering. The photographic device 104 field of view is predefined. The two lasers 102, 103 generate individual single line of light 108, 118 that project inside of the photographic device 104 field of view. The reflected lines of light 120, 121 will be imaged on to the photographic device 104. Due to the object feature's 112 height along the Z-axis, the reflected lines 120, 121 will be imaged as distorted lines. The obtained distorted lines include the object feature's z-directional information. The lasers 102, 103 location as well as projection angles can be varied by design. Since the photographic device 104 will obtain the two reflected laser lines 120, 121 simultaneously, the laser projection angle needs to be set up properly so that the lines 120, 121 will not be overlapped each other in the photographic device 104 image within the pre-designed measurable height range along the Z-axis when the photographic device 104 grabs the reflected laser lines 120, 121 from a certain object feature 112. To do adjust the proper laser projection angles, mirrors are used in this exemplary illustration. However, lasers 102, 103 can be directly projected with a proper projection incident angle setup. Illuminator 107 is attached so that when the photographic device 104 needs to view an actual object feature 112 view, the photographic device 104 can obtain enough illumination for the object feature view. However, when the measurement is started, the illuminator 107 may need to turn off so that the photographic device 104 can images a certain range of light wavelength for better image processing purpose. The present invention includes variations of projection methods such as utilizing mirrors 109, 111 for detouring the laser lights 108, 118 or direct projection of lasers 102, 103 with an incident angle. Also the various light sources (i.e., different wavelengths) can be used as long as the photographic device 104 can image the wavelengths of the projected light source. The various photographic devices can such as Photo-Sensitive Device (PSD), Charged-Coupled Device (CCD) or Complementary Metal Oxide Semiconductor (CMOS) cameras. The frame grabber 113 is interfaced between processor 116 and photographic device 104. Laser/illuminator controller 114 controls the Illuminator 107 and Lasers 102, 103. The memory 117 is used to store program algorithms to process the images and control additional devices such ad laser 102, 103 and illuminator 107. With the proper processing of the image obtained by the photographic device 104 through frame grabber 113, processor 116 and memory 117, processed resultant data can be displayed through display device 115, and also can be stored in to the memory 117 for further processing. The calibration plane 213 will be used as a reference plane for the object height setup. The photographic device active image area size can be varied as long as the device can obtain the desired reflected lines image (i.e., CMOS camera is used as a photographic device in this exemplary illustration. The image area size is 1288×1032, as an example) The lighting device wavelength could be any range as long as the photographic device with proper lens system can image the reflected wavelength from the surface of the object features. Number of lighting devices could be plural for the desired multiple lines generation with their line projection angles respectively. Also, the configurations for the lighting devices and the photographic device could be varied as long as the reflected lines are in the photographic divide's field of view. Other lighting device setup examples could be utilization of multiple lines projections from one lighting source or four lines projection from four different directions with 90-degree incident angle distance.

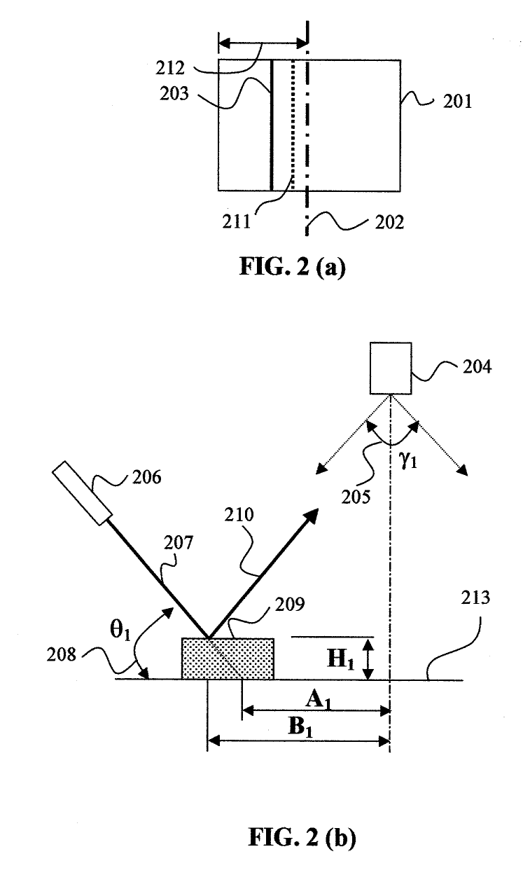

FIG. 2(a) and FIG. 2(b) are a detailed schematic diagram for dimensional measurement method (for left-half image analysis) according to the present invention. In FIG. 2(a) shows photographic device image 201. Since the invented measurement head consists of multiple light lines (The FIG. 1 shows two light lines as an exemplary illustration.), the photographic device image needs to be divided properly. The image centerline 202 is used for two light line application. When the laser 206 projects a line of light 207 with an incident projection angle 208 to the object 209, the reflected line from the object feature 209 will be imaged as 203 for a flat surface. The photographic device 204 will obtain the image 201 with a reflected line of light 203 on the left half size 212 of the image active area 201. To obtain the reflected line of light 210, the incident projection angle and the laser need to be properly positioned. Also the viewing angle for the photographic device 205 needs to cover the reflection range of the object so that the photographic device can obtain the image 201.

To obtain three-dimensional information for the object features in the photographic image obtained, a standard optical triangulation principals. Based on the FIG. 2(b), the object height H₁ could be obtained by the following equation:

H₁=(B₁−A₁) tan (θ₁)

The will be predefined and can be provided from the laser projection setup. To calculate the (B₁−A₁), photographic device 204 calibration needs to be preceded. The calibration includes a relationship definition between photographic device image 201 coordinates and their corresponding world coordinates. To do the photographic device calibration, the calibration plane 213 should be defined. The world coordinate A₁ is predefined by the laser project angle 208 and laser position setup. The world coordinates A₁ and B₁ can be obtained from the photographic device image (211 for A₁ and 203 for B₁) by utilizing the calibration data.

The laser position and projection angle should be setup properly so that the photographic device 204 can image the reflected line of light 210 inside the viewing angle 205. The object height H should be in the range of pre-defined range so that the reflected line of light 203 should be imaged within the photographic device active imaging area 201 (for the left-side projection (FIG. 2(b), the active imaging area will be on the left-half size 212 of the device image 201.).

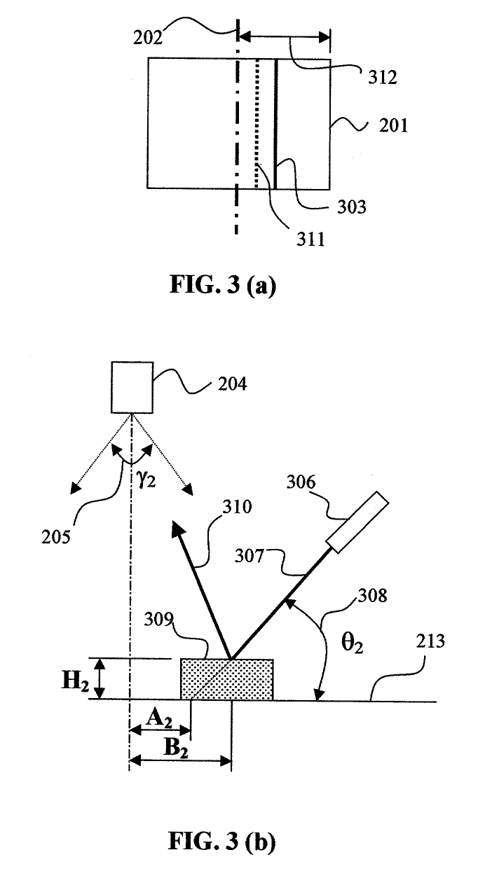

FIG. 3(a) and FIG. 3(b) are a detailed schematic diagram for dimensional measurement method (for right-half image analysis) according to the present invention. In FIG. 3(a) shows photographic device image 201. Since the invented measurement head consists of multiple light lines (The FIG. 1 shows two light lines as an exemplary illustration.), the photographic device image needs to be divided properly. The image centerline 202 is used for two light line application. When the laser 306 projects a line of light 307 with an incident projection angle 308 to the object 309, the reflected line from the object feature 309 will be imaged as 303 for a flat surface. The photographic device 204 will obtain the image 301 with a reflected line of light 203 on the right half size 312 of the image active area 201. To obtain the reflected line of light 310, the incident projection angle and the laser need to be properly positioned. Also the viewing angle for the photographic device 205 needs to cover the reflection range of the object so that the photographic device can obtain the image 201.

To obtain three-dimensional information for the object features in the photographic image obtained, a standard optical triangulation principals. Based on the FIG. 3(b), the object height H₂ could be obtained by the following equation:

H₂=(B₂−A₂) tan (θ₂)

The will be predefined and can be provided from the laser projection setup. To calculate the (B₂−A₂), photographic device 204 calibration needs to be preceded. The calibration includes a relationship definition between photographic device image 201 coordinates and their corresponding world coordinates. To do the photographic device calibration, the calibration plane 213 should be defined. The world coordinate A₂ is predefined by the laser project angle 308 and laser position setup. The world coordinates A₂ and B₂ can be obtained from the photographic device image (311 for A₂ and 303 for B₂) by utilizing the calibration data.

The laser position and projection angle should be setup properly so that the photographic device 204 can image the reflected line of light 310 inside the viewing angle 205. The object height H₂ should be in the range of pre-defined range so that the reflected line of light 303 should be imaged within the photographic device active imaging area 201 (for the right-side projection (FIG. 3(b), the active imaging area will be on the right-half size 312 of the device image 201.).

As described the measurement method using FIG. 2(b) and FIG. 3(b), one photographic device 204 can obtain two distorted lines 203, 303 of light reflected to the photographic device active image area 201. For multiple line projection using light source of lines, the photographic device active image area can be divided into several areas as described above.

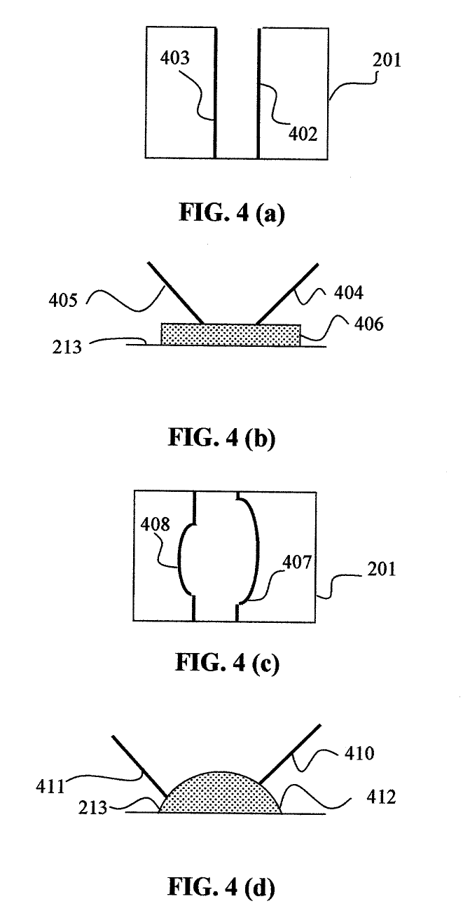

FIG. 4(a), FIG. 4(b), FIG. 4(c) and FIG. 4(d) are illustrations of photographic image samples corresponding to the various object features. The lines 402, 403 of the image 201 in

FIG. 4(a) represent the heights for the intersection lines between the object feature 406 surface and the projected lines of light 404 and 405 respectively. The distorted lines 407, 408 of the image 201 in FIG. 4(c) represent the heights for the intersection lines between the object feature 412 surface and the projected lines of light 410 and 411 respectively. Once the lines of light projection angles for both left and right projection cases are determined, the reflected lines in the photographic device for the both sides projections will be moved along a single direction (← and → directions respectively) as the object feature height is getting higher. For example, left-size projection case (FIG. 2(b), the line of the light 211 on the calibration plane 213 will be moved toward left (←) as the object feature height is getting higher as the reflected distorted line 203 shown in the FIG. 2(a) so that the reflected distorted image will not be in the left-side of the active imaging area 212. For right-side projection case (FIG. 3(b) as well, the reflected distorted line 303 will be only located in the right-hand side of the active imaging area 312 of the photographic device image 201 and will be moved toward right (→) as the object feature height is getting higher. However, if the object height is higher than the pre-designed value (in other words, height measurement limit) and the calibration plane 213, the reflected distorted lines image 203, 303 may not be within the photographic device imaging area 201 so that the apparatus cannot measure the object feature height. If the object is lower than calibration plane 213, the reflected distorted lines image 203, 303 will be moved toward the reversal direction (for left and right projection cases, reflected distorted line images will be moved toward the image centerline 202, → and ← directions respectively.).

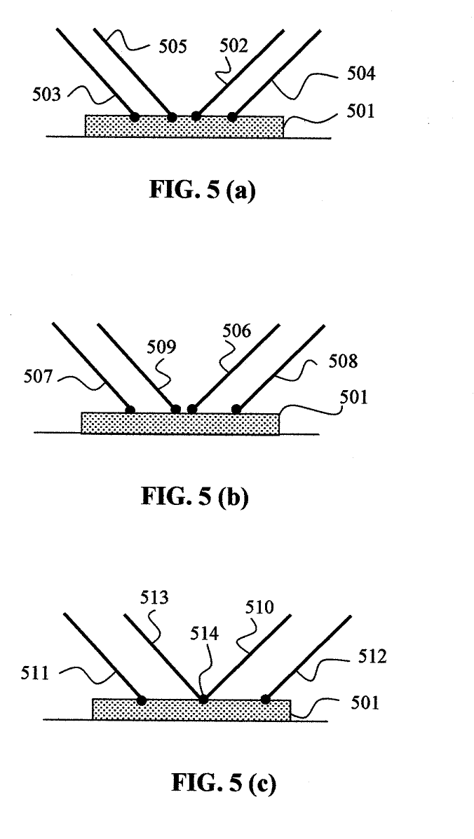

FIG. 5(a), FIG. 5(b) and FIG. 5(c) illustrate dual-scanning method in the content of measuring points. FIG. 5(a) shows scanning method to increase measurement speed up to double by defining a certain step of traversing mechanism movement. For example, the two lines 502, 503 move together at a same time and the subsequent measurement points 504, 505 can be measured between the previous measured points 502, 503. The proper movement step can be calculated so that all the measured points have the same interval/step of measurements. FIG. 5(b) shows measurement points measured without correct measurement step calculations. Without proper movement step calculation, the measurement points 506, 507 and subsequent measurement points 508, 509 may have different measurement intervals. FIG. 5(c) shows a scanning method to increase measurement accuracy by measuring points twice. For example, the two lines 510, 511 move together at a same time, the movement step for the subsequent measurement point 512, 513 can be calculated so that all the measured points can be measured twice, once from left-side projection setup FIG. 2(b) and another from right-side projection setup FIG. 3(b). The point 514 will be measured twice, one from 510 and another from 513 as shown in the FIG. 3(c). The two measurement points 510, 513 can be post-processed (i.e., averaged) to obtain better measurement accuracy for the point 514.

When the components (i.e., photographic device field of view and lighting device projection angles) of the measurement head disposition are defined, inspection resolution for X, Y and Z axes can be defined. However, based on the optical calibrations method, the resultant resolutions could be varied. When the range of Z-axis measurements range is defined, the corresponding imaging area of the photographic device can be defined. Therefore, one photographic device can process the image of multiple lines of light reflected from the object features. For example, CCD or CMOS camera can take multiple lines of image at the same time and process the lines separate based on the corresponding optical calibration results. However, since the multiple lines have their own pre-fixed projection angles, optical calibration results will be different among the lines.

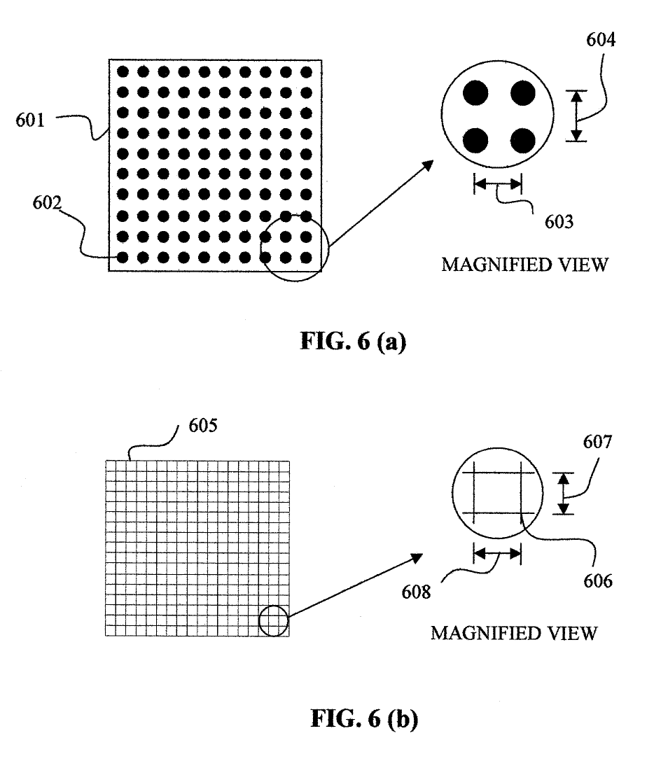

FIG. 6(a) and FIG. 6(b) are calibration target samples that can be used for photographic device calibration according to the present invention. The provided calibration targets 601, 605 can be used for photographic device calibration to interpret the photographic device image pixel coordinates into world coordinates. FIG. 6(a) consists of small dots with the same pitch 603, 604 between dots along horizontal axis and vertical axis. To perform optical calibration, the centroid of the dot 602 in the photographic device image can be obtained using image processing algorithms. After obtaining all the centroids of the dots in the image pixel coordinates, the coordinates could be correlated to the real world coordinates for the calibration target. The photographic device calibration can be done using Least Square Error method or Bi-linear interpolation method, as examples. FIG. 6(b) as well can be utilized for the photographic device calibration. To use the calibration target 605, the intersection points such as the intersection point 606 can be extracted using image processing algorithms. The pitch 607, 608 can be the same. The extracted intersection points in the image pixel coordinates can be correlated to the intersection points in the world coordinates. The calibration mathematics can be the same as the calibration target with dots 602 once the image pixel coordinates and the world coordinates for the intersection points for the calibration target are obtained.

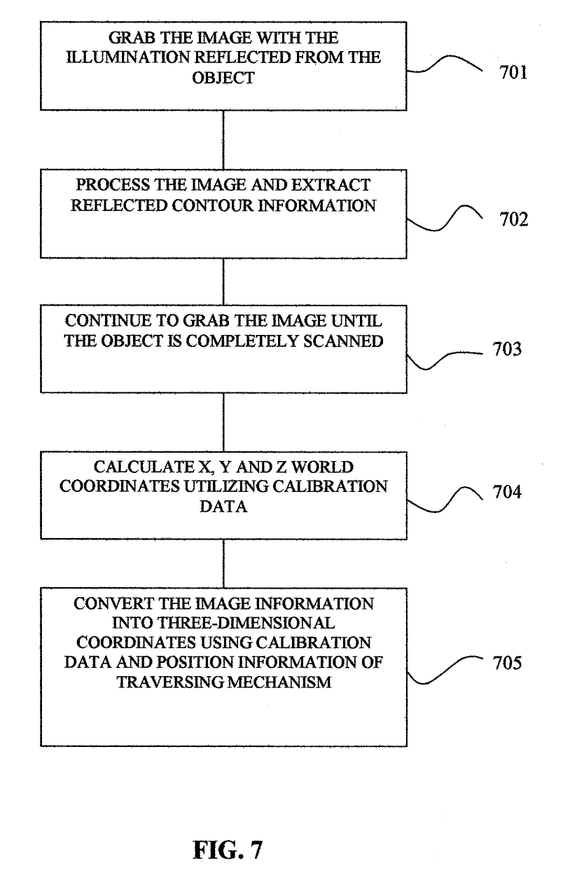

FIG. 7 is a flowchart of the dimensional measurement procedures To carry out the dimensional measurement, the photographic device 104 needs to grab the image 701 to obtain the distorted contour lines of light from the object feature surface. The frame grabber 113 is used to obtain the photographic device image to transfer the data to the processor 116. Once the processor receives the image data from the frame grabber, software algorithms will be used to process the image 702 to extract the object feature height information. Scanning will be carried out till the defined area is completely scanned 703. Using photographic device 104 calibration data and optical setup data (i.e., projection angles 208, 308), the obtained reflected contour for the object feature could be converted into world coordinate space 704. Since the scanning utilize traversing mechanism to scan the desired areas, the converted world coordinates and the traversing mechanism coordinates need to be added together 705, which finally can represent the three-dimensional representation of the desired object feature.

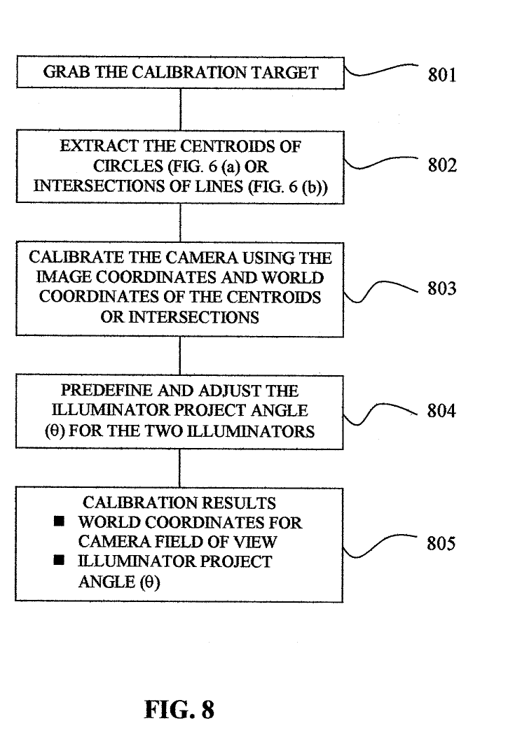

FIG. 8 is a flowchart of the photographic device calibration procedure for the measurement according to the present invention. The proposed calibration target 601 or 605 can be used for the photographic device calibration. Using the photographic device 104, the calibration target image can be grabbed through the frame grabber 801. The centroids for the dots target or the intersections of the grid lines can be extracted 802. Using Least square Error Method or Bi-sectional Interpolation Method, the obtained calibration target information such as centroids or intersections in the content of image pixel coordinates can be correlated on to the world coordinates for the centroids or intersections for the calibration target 803. The results of the correlation will be used for the apparatus optical calibration for object feature height information conversion. The laser projection angles 208, 308 needs to be defined based on the apparatus design 805, and the defined angles will be utilized for the apparatus optical calibration for height measurement.

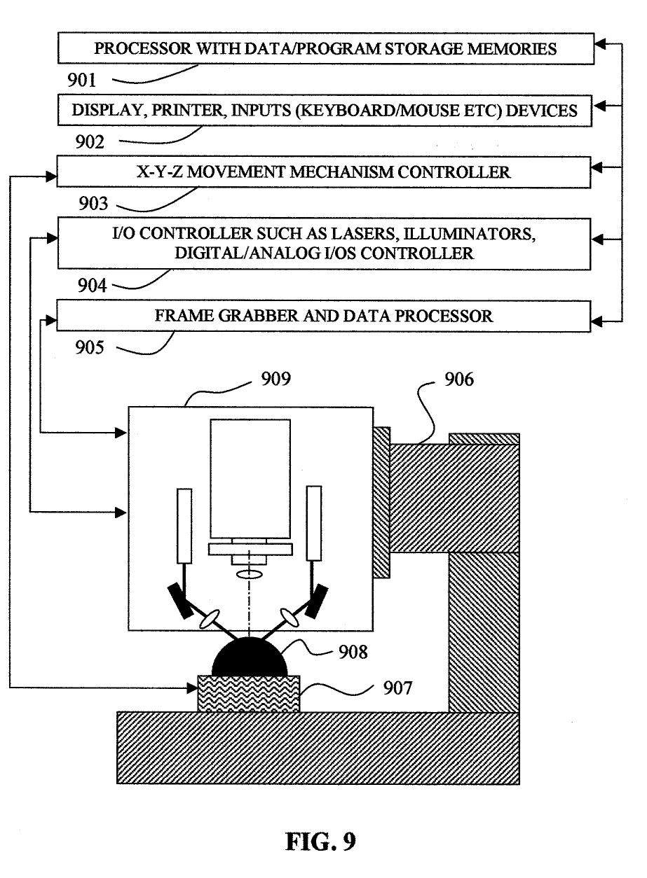

FIG. 9 is a dimensional measurement apparatus block diagram of a second exemplary representative embodiment of the present invention. The block diagram shows the dimensional measurement apparatus integrated with necessary additional devices such as processor and memories 901 for image processing and algorithms for obtained data handling to extract the information for the object feature height as well as representation of the object features, display device with input devices 902 for resultant data display. The measurement head will be attached to the traversing mechanism, or the measurement head will be fixed and traversing mechanism can be located at the lower of the measurement head so that the object features can be scanned using the X-Y traversing mechanism. The Z-axis will be used to adjust the calibration plane 213 as a reference. Therefore the system equips the X-Y-Z traversing mechanism 903. I/O controller such as illuminator and lasers will be controller by the I/O controller 904. The frame grabber and image data processor 905 will be integrated to process the photographic device image. In FIG. 9, the measurement head 909 is attached to the fixed frame 906 to hole the head, and X-Y-Z traversing mechanism 907 is located at the below of the measurement head. To measure the object feature 908, the feature needs to be located below the measurement head always in this setup. However, the present invention includes that the measurement head can be attached to the traversing mechanism so that the object feature can be located at the fixed location on the calibration plane.

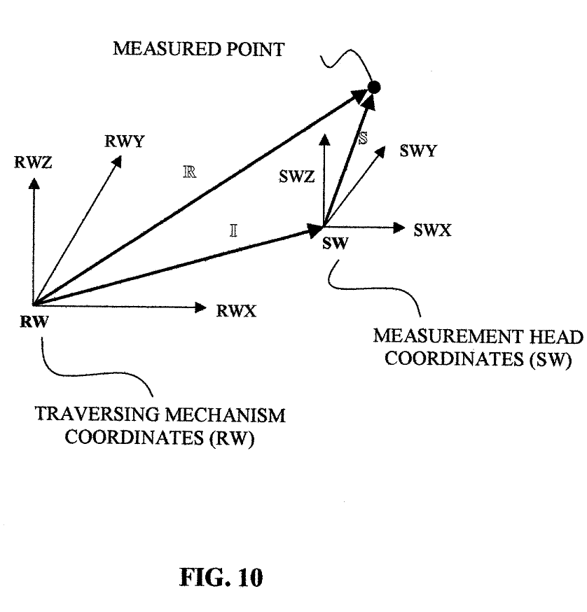

FIG. 10 is coordinate systems to obtain the three-dimensional information using dimensional measurement apparatus using X-Y-Z traversing mechanism. The photographic device 104 needs to be calibrated to setup the relationship between photographic device pixel coordinates and the world coordinates (RW) of the corresponding calibration targets (i.e., centriods of circles or intersections of the line grids). Utilizing the photographic device 104 calibration results and the precisely adjusted lighting device projection angles 208, 308, standard optical used to obtain the geometric and optical relationships for the measurement head assembly 909. When the images are being grabbed, the traversing mechanism 907 signal will be utilized to synchronize the traversing mechanism locations and the measurement data obtained through the measurement head 909.

R=I+S

Where, R is an actual measured point in the world coordinate system (RW), I is a fixed vector to represent the geometrical relationship between world coordinates and the measurement head coordinates and S is a measured point coordinates in the measurement head coordinate system (SW). The RWX, RWY and RWZ are for the world coordinates along the X-, Y- and Z-axes. The SWX, SWY and SWZ are for the sensor coordinates.

As is described in considerable detail from the foregoing, the present invention provides a means of two- and three-dimensional measurement method and process for the object features. Also utilizing the present invention of the process, two- and three-dimensional measurement apparatus is presented, which include in present invention. Although the embodiments are described for solder paste inspection as well as BGA inspection, the present invention can also be applied to many different types semiconductor chip carriers (packages) such as PGAs (Pin Grid Arrays), QFPs (Quad Flat Packages), Flip Chips and several types of J-leaded packages. The present invention can be applied to the object feature representation and reconstruction as well. However, the present invention can be achieved through various specifications of the devices and apparatus, and that various modifications, both as to the apparatus details and operating procedures, without departing from the sprit and the scope of the invention.

What is claimed is:

1. Dimensional measurement apparatus determining at least one dimension of at least a portion of an object feature comprising:
a) Single photographic means disposed above the object to be measured comprising dual imaging area divisions for dual incident light projections processing;
b) Dual illumination projection means disposed at the opposite directions each other;
c) Measurement head means comprising single photographic means a) and dual illumination projection means b);
d) A processor, interfaced with the measurement head to obtain the scanned image and process the image, convert it to three-dimensional information using processing algorithms and calibration data.

2. The apparatus of claim 1 further comprising:
a) calibration means for dual illumination projections;
b) height calculations means for dual illumination projections;
c) photographic image processing means for dual illumination projections;
d) scanning means with dual illumination projections;
e) photographic device calibration means with dual image area divisions.
